(19) United States
(12) Patent Application Publication
(10) Pub. No.: US 2025/0131611 A1
(43) Pub. Date: Apr. 24, 2025

(54) VIRTUAL CAMERA SOURCES SHOWING REGIONS OF INTEREST OF DEVICES

(71) Applicant: Brainlab AG, Munich (DE)

(72) Inventor: Rainer BIRKENBACH, Munich (DE)

(21) Appl. No.: 18/686,566

(22) PCT Filed: Dec. 22, 2022
(86) PCT No.: PCT/EP2022/087529

§ 371 Date: Feb. 26, 2024

(51) Int. Cl. G06T 11/00; G06T 3/16; G06T 5/80; G06T 7/00; G06T 7/11; G06T 7/174; G06T 7/215

(52) U.S. Cl. CPC G06T 11/00; G06T 3/16; G06T 5/80; G06T 7/0012; G06T 7/11; G06T 7/174; G06T 7/215; G06T 2207/10016; G06T 2207/30004; G06T 2210/41

(57) ABSTRACT

The disclosed method encompasses receiving an input video stream showing at least a part of at least one device which is in use in a medical environment. A device has a region of interest (ROI). The area of the input video stream which shows the region of interest of a device is extracted from the input video stream and provided as an ROI video stream. The ROI for example comprises a display, such that the information shown on the display is provided in the ROI video stream.

### FIELD OF THE INVENTION

The present invention relates to a computer-implemented data processing method of providing information about at least one device used in a medical environment as a video stream of a virtual camera from an input video stream, a corresponding computer program, a computer-readable storage medium storing such a program and a computer executing the program, as well as a digital operating room system comprising the aforementioned computer.

### TECHNICAL BACKGROUND

The present invention has the object of enabling more flexible recordings of medical procedures, for example for documentation purposes, even if a device which has no video signal output port is used in the procedure.

The present invention can be used in the context of a digital O.R. of Brainlab AG.

Aspects of the present invention, examples and exemplary steps and their embodiments are disclosed in the following. Different exemplary features of the invention can be combined in accordance with the invention wherever technically expedient and feasible.

### EXEMPLARY SHORT DESCRIPTION OF THE INVENTION

In the following, a short description of the specific features of the present invention is given which shall not be understood to limit the invention only to the features or a combination of the features described in this section.

The disclosed method encompasses receiving an input video stream showing at least a part of at least one device which is in use in a medical environment. A device has a region of interest, ROI. The area of the input video stream which shows the region of interest of a device is extracted from the input video stream and provided as an ROI video stream. The ROI for example comprises a display, or a part of a display, such that the information shown on the display, or the part of the display, is provided in the ROI video stream.

### GENERAL DESCRIPTION OF THE INVENTION

In this section, a description of the general features of the present invention is given for example by referring to possible embodiments of the invention.

In general, the invention reaches the aforementioned object by providing, in a first aspect, a data processing method of providing information about at least one device used in a medical environment, in particular if the device is in use in the medical environment. The method comprises executing, on at least one processor of at least one computer (for example at least one computer being part of a navigation system), the following exemplary steps which are executed by the at least one processor.

In a (for example first) exemplary step, an input video stream captured using a camera and comprising a sequence of images showing one or more regions of interest, ROI, is acquired, wherein a region of interest is a part of a device. In this document, the term “device” means a device used in, or in use in, a medical environment.

The camera is for example mounted to a tripod, a cart or any other mobile or fixed carrier or is mounted to a wall or the ceiling of a room, like an operating room. The camera can for example be mounted behind a screen.

A video stream, like the input video stream, an ROI video stream or an output video stream described later, represents a moving image, for example a two-dimensional moving image. The moving image shows at least one region of interest, wherein a region of interest is an area or a volume in space, like in the operating room. At this area or in this volume, a part of a device is located.

A video stream can be in any suitable format, like a sequence of independent images, in compressed or uncompressed form. It could use any suitable video codec to compress the video stream.

In a (for example second) exemplary step, one or more areas in the images of the input video stream which show the one or more regions of interest are identified. In an example, there is one area for each region of interest. An area is a part of an image. An area is for example a set of neighbouring pixels and for example forms a two-dimensional set of pixels. An area showing a particular region of interest is for example identified in multiple or all images of the input video stream.

In a (for example third) exemplary step, an ROI video stream for each of the one or more areas is generated. An ROI video stream is a sequence of images showing the region of interest. In the most simple example, the images of an ROI video stream exactly represent the area identified in the previous step. This means that the area is simply copied from the input video stream into the corresponding ROI video stream. However, it is possible to edit or process the image data of the corresponding area before it is formed into the ROI video stream. This may include color manipulation and/or contrast manipulation. This may further include geometric processing, like scaling, rotation, deformation or a combination thereof.

In one embodiment, a region of interest comprises a display, a control element or a status indicator. A display can be any means that displays information, for example as an array of pixels. The term “display” in this context also covers any other means for indicating a physical quantity, like a rotating pointer, a segment display or a rotameter. A control element can be an input means manipulated by a user, like a switch, a button, a turning knob, a fader or the like. A status indicator can for example be a status lamp, and the status can be indicated by the color and/or the intensity of the light emitted by the status lamp. The status indicator could be a passive indicator or a mechanical or electromechanical indicator, for example using a moveable cover for covering or revealing a surface indicating the status.

As explained above, the image data of the input video stream may be processed for forming the ROI video stream. In one embodiment, this comprises the step of removing distortion from an ROI video stream, thus providing a planar view onto the corresponding region of interest. This is particularly useful if the region of interest is not perpendicular to the line of sight from the camera to the region of interest.

In one embodiment, the method further comprises the step of providing an ROI video stream as a virtual video source. A virtual video source provides one ROI video stream. The video source is called virtual since it is no physical device like a camera. The virtual video source can be used with an input of a video editing or mixing apparatus or software.

In one embodiment, the images in the input video stream are 360° images. The camera capturing the 360° image can for example be a panoramic camera imaging 360° in the horizontal direction or a fisheye camera or similar camera pointing downwards. Said camera is for example mounted to a ceiling.

There are numerous possibilities for identifying an area showing a region of interest in the images of the input video stream, some of which will be described below.

In one embodiment, identifying an area involves identifying a device in the input video stream, obtaining information which defines the corresponding region of interest from a database and identifying the area based on the obtained information. Identifying a device in the input video stream means identifying the device in the images of the input video stream.

Identifying a device for example involves image recognition, for example using sample images of devices. The database associates a particular device with a region of interest relative to the device. When the device was identified in the input video stream, the spatial position of the device in the images of the input video stream is known, and thus also the position of the area showing the region of interest associated with the device via the database.

Identifying a device might mean identifying the model of the device. The model for example means the model name and optionally the manufacturer. The database might store a template of the model. The template for example associates the model with the geometry of the device, in particular the location of a region of interest relative to the housing of the device.

A particular device or a particular model might have more than one region of interest. In this case, the method identifies one area corresponding to one ROI, multiple areas corresponding to multiple ROIs or one area for each ROI. The method might then generate an ROI video stream for each identified area. However, an ROI video stream might also cover two or more areas of the same device. For which of the ROIs an area is to be identified might depend on which medical procedure, or which workflow step of the medical procedure, is performed. This information can also be stored in the database.

As an alternative, the method involves presenting the ROIs associated with a particular model identified in the input video stream to a user, obtaining ROI user input identifying one or more of the presented ROIs and identifying areas corresponding to the selected ROIs. ROI video streams are then generated for the identified areas corresponding to the selected ROIs.

In one implementation, identifying a device involves identifying an identification tag of the device in the input video stream. This identification tag can be a model number indicated on the device. In this case, text recognition is performed on the input video stream. The identification tag can alternatively be a bar code or QR code identifying the model of the device or the particular device.

In one embodiment, identifying an area uses the position of the corresponding device relative to the camera. This is advantageous in a known setup of the camera and the device, which can be registered for example when equipping an operating room. If said relative position is known, the position of the area showing the region of interest is known from geometric calculations.

In one embodiment, the method further comprises the step of acquiring user input data indicating a spatial position in the input video stream, wherein an identified area in the images of the input video stream is an area including the position indicated by the user input data. The identified area showing the region of interest is an area including the position indicated by the user and having a predetermined size and/or shape or a size and/or shape also input by the user. It is also possible that the user input directly designates an area to be used as an identified area, for example by drawing a boundary onto the input video stream.

In one implementation, the user input is combined with identifying a device in the input video stream. The image recognition for identifying the device is for example limited to an area surrounding the spatial position indicated by the user.

In one embodiment, the method further comprises the step of acquiring user input data indicating a type of a device, wherein an area in the images of the input video stream is identified based on the indicated type of the device. In this case, image recognition in the input video stream for identifying a device can be limited to sample images belonging to the indicated type of device rather than using all available sample images. In this context, the word “type” means the purpose of the device. The type is for example “heart rate monitor”. The term “model” refers to a particular variant. So multiple models can be of the same type.

In another example, the indicated type of device is associated with a set of device model names and text recognition in the input video stream is limited to the device model names in said set.

The user input can for example involve a selection in a given list of types of device or free text input of the type of device.

In one embodiment, identifying an area in the images of the input video stream uses artificial intelligence, AI. The artificial intelligence uses a standard AI algorithm fed with appropriate training data. In the present case, each dataset of the training data comprises an image as input data and an area showing a region of interest as desired output data. The area showing the region of interest in the training data may be manually input by a user, for example by designating an area in the image of the training data.

In one embodiment, identifying an area involves finding a spatial section of the input video stream that is generally static, but comprises a variable sub-section. It shall be noted that the position of said section might change over the sequence of images of the input video stream. The variation in the variable sub-section is an indication that this sub-section is a region of interest. In an example, the section shows a medical device which has a static structure, and the sub-section shows a display of the device which displays changing information and is thus variable.

In one embodiment, identifying an area in the images of the input video stream is based on which medical procedure is currently performed. The type of medical procedure is for example associated with a particular set of devices to be used, for example via a database of medical procedures. The devices in this set of devices can be used for identifying an area in the images of the input video stream, for example by image or text recognition. In this case, image recognition can be performed using only sample images of devices comprised in the set of devices.

In one implementation, identifying an area in the images of the input video stream is based on which workflow step of the medical procedure is currently performed. A medical procedure typically involves multiple workflow steps. Each workflow step can be associated with a different set of medical devices used in the workflow step, for example via the database of medical procedures. This means that the set of medical devices which are searched in the input video stream might change over time, and depends on the workflow step that is currently performed.

In one embodiment, a region of interest is tracked in the input video stream over time. This means that one or more of the position, the shape and the size of an area associated with a particular region of interest may change from one image to another, for example if the corresponding device moves relative to the camera or vice versa. The ROI video stream thus always shows the region of interest, irrespective of the area of the image of the input video stream which shows the region of interest.

In one embodiment, a region of interest comprises a control element and the method further comprises the steps of transforming the status of the control element into a graphical representation and of embedding the graphical representation in the corresponding ROI video stream. This embodiment does not simply use a part of the input video stream as an ROI video stream, optionally after removing distortion, but analyzes the identified area representing the control element to determine the status of the control element.

The status of the control element for example means a value which is set using the control element or means a position of the control element. If the status means a value, the graphical representation may be a numerical value or a graphic representing the value, like a bar. If the status of the control element means a position, the graphical representation may be a text like “on” or “off” or any other text describing the status of the control element. The graphical representation might also represent the history of the status of the control element, which means that it shows the status of the control element for a past period of time.

Embedding the graphical representation might involve overlaying the graphical representation over the images of the ROI video stream, for example in an opaque or translucent manner. The graphical representation might comprise transparent pixels.

In one embodiment, a region of interest comprises a status indicator and the method further comprises the steps of transforming the status indicated by the status indicator into a graphical representation and of embedding the graphical representation in the corresponding ROI video stream. This embodiment does not simply use a part of the input video stream as an ROI video stream, but analyzes the identified area representing the status indicator to determine the status of the device.

The status indicator can be a light emitting element or a plurality of light emitting elements. The status can be represented by whether a light emitting element is on or off, the color of the light emitted by the light emitting element or whether the light emitting element is flashing or not.

The graphical representation may be a text like “on” or “off” or any other text describing the status of the device as represented by the status indicator. The meaning of the states of the status indicator is typically explained in the manual of the device, and the description of this meaning might be used as the text shown in the graphical representation. The graphical representation might also represent the history of the status of the device, which means that it shows the status of the device for a past period of time.

Embedding the graphical representation might involve overlaying the graphical representation over the images of the ROI video stream, for example in an opaque or translucent manner. The graphical representation might comprise transparent pixels.

In one embodiment, a region of interest comprises a status indicator and the method further comprises the steps of identifying the status indicated by the status indicator and testing the status for plausibility. If the result is not plausible, the method might involve outputting a corresponding warning, for example as a graphical representation embedded in the corresponding ROI video stream. For example, a particular status might be associated with the medical procedure or a workflow step of the medical procedure, for example via the database of medical procedures.

In one implementation, a graphical representation might further indicate a time stamp. The ROI video stream is thus a documentation of a status or a set value.

In one embodiment, generating an ROI video stream involves generating a synthetic ROI video stream. A synthetic ROI video stream is not generated from an area of the input video stream, but rather synthesized using information shown in the area of the input video stream which shows the region of interest. This embodiment is particularly advantageous if the quality of the ROI video stream would not be sufficient if the ROI video stream was based on a (distortion-corrected) part of the input video stream. For example, reflections might make information shown on a display of the device hard to identify.

In one example, the region of interest of a device comprises a display showing a graph. Generating the synthetic video stream involves analyzing the graph as shown in the input video stream and generating a synthetic version of the graph as the content of the ROI video stream. The synthetic version of the graph might be added to a generic graphic of the display of the device to mimic the display of the real device in the ROI video stream.

In one example, the region of interest comprises a numerical display showing a value with one or more digits. Generating the synthetic video stream involves detecting the number shown on the numerical display and generating the ROI video stream from a graphical representation of this value. Similar to the previous example, a generic graphic of the region of interest, including the numerical display, is amended by adding a graphical representation of said value to mimic the numerical display of the real device.

In other examples, the region of interest comprises a status indicator or a control element, the status of the status indicator or the setting the control element is detected in the corresponding area of the input video stream and the ROI video stream represents a synthesized version of the status indicator or the control element having the detected status or setting, respectively.

In one embodiment, the camera comprises two or more camera modules each generating a raw video stream, the input video stream is synthesized from the two or more raw video streams and the ROI video stream is generated from at least one of the raw video streams.

A camera typically has a limited field of view, such that the images of the input video stream might be stitched from the output of two or more cameras. In this embodiment, the video data of the ROI video stream might not be taken from the resulting stitched input video stream, but from one or more of the raw video streams. This avoids reduced image quality in areas of the input video stream in which two raw video streams overlap or in which the image geometry is distorted due to the stitching. If the region of interest is completely imaged by a single raw video stream, the video data of the ROI video stream can be completely derived from said single raw video stream.

In one embodiment, the method further comprises the step of generating an output video stream from at least one ROI video stream. The output video stream for example comprises two or more ROI video streams. This example means that an output video stream representing a sequence of images is generated, wherein the output video stream comprises more than just one ROI video stream.

In one example, the output video stream is based on a basic video stream, which for example shows at least a part of a patient or any other content. The basic video stream is supplemented by at least one ROI video stream, for example by overlaying the ROI video stream over the basic video stream. There are many different options for arranging the respective video streams (the basic video stream and/or the at least one ROI video stream) to obtain the output video stream. Some of the options are described below, and it lies within the scope of this document to combine two or more options as appropriate.

In one example, the at least one ROI video stream is arranged in the output video stream based on user preferences. The user at which the output video stream is targeted is known, for example by identifying said user by means of image recognition, reading an identification tag or manual input. The user preferences define the layout of the output video stream. The layout of the output video stream for example defines which basic stream is to be used, which ROI video streams are to be used and how the ROI video streams to be used are to be combined with the basic video stream. The user preferences for multiple users might be associated with the respective users in a user database.

The user preferences might be created using an editor in which the layout of the output video stream is defined, for example by the particular user.

In one example, the at least one ROI video stream is arranged in the output video stream based on which medical procedure is currently performed. The layout of the output video stream is associated with the medical procedure, for example via the database of medical procedures mentioned above or a separate database. The same definitions as for the previous example apply here.

In one implementation, the at least one ROI video stream is arranged in the output video stream based on which workflow step of the medical procedure is currently performed. The layout of the output video stream can thus vary with each workflow step.

In one implementation, multiple layouts are associated with the same medical procedure or the same workflow step. In this case, the user might be queried for selection information indicating which layout to use.

In one example, the at least one ROI video stream is arranged in the output video stream using artificial intelligence. The artificial intelligence might for example be used to define the layout of the output video stream. The artificial intelligence can be trained using multiple sets of training data each describing a desired layout of the output video stream as an output and at least one of a user identity and a type of medical procedure as input data.

In one embodiment, the method further comprises the step of adding a graphical representation of device information to the ROI video stream, or one or more of multiple ROI video streams. The device information identifies the device whose region of interest is represented in the ROI video stream. The representation of the device information can for example be a text identifying a model name, optionally including the name of the manufacturer, of the device, or an image of the device. The graphical representation of the device information is for example overlaid over the ROI video stream.

In a second aspect, the invention is directed to a computer program comprising instructions which, when the program is executed by at least one computer, causes the at least one computer to carry out the method according to the first aspect. The invention may alternatively or additionally relate to a (physical, for example electrical, for example technically generated) signal wave, for example a digital signal wave, such as an electromagnetic carrier wave carrying information which represents the program, for example the aforementioned program, which for example comprises code means which are adapted to perform any or all of the steps of the method according to the first aspect. The signal wave is in one example a data carrier signal carrying the aforementioned computer program. A computer program stored on a disc is a data file, and when the file is read out and transmitted it becomes a data stream for example in the form of a (physical, for example electrical, for example technically generated) signal. The signal can be implemented as the signal wave, for example as the electromagnetic carrier wave which is described herein. For example, the signal, for example the signal wave is constituted to be transmitted via a computer network, for example LAN, WLAN, WAN, mobile network, for example the internet. For example, the signal, for example the signal wave, is constituted to be transmitted by optic or acoustic data transmission. The invention according to the second aspect therefore may alternatively or additionally relate to a data stream representative of the aforementioned program, i.e. comprising the program.

In a third aspect, the invention is directed to a computer-readable storage medium on which the program according to the second aspect is stored. The program storage medium is for example non-transitory.

In a fourth aspect, the invention is directed to at least one computer (for example, a computer), comprising at least one processor (for example, a processor), wherein the program according to the second aspect is executed by the processor, or wherein the at least one computer comprises the computer-readable storage medium according to the third aspect.

In a fifth aspect, the invention is directed to a digital operating room system comprising the computer of the fourth aspect. The digital operating room system optionally further comprises at least one of a camera which generates the input video stream and a display which shows one or more ROI video streams and/or the output video stream.

The digital operating room system may further comprise video processing means for generating the output video stream and/or recording means for recording one or more ROI video streams and/or the output video stream.

The digital operating room system can optionally comprise an additional ROI camera which is specifically directed to a region of interest. The output of the ROI camera can be used to generate a corresponding ROI video stream, which can be generated and/or used as any other ROI video stream.

According to the present invention, the artificial intelligence in all embodiments can be trained using federated or collaborative learning. Multiple digital operating room systems can be installed at different locations. Local training data at the respective locations is used to train a local model of the AI, and only parameters resulting from the local training is exchanged. The parameters might be transmitted to some or all other locations and the local AI models might be adapted locally. However, the parameters from some or all locations might be transmitted to a central site where the AI model is updated and distributed to the different digital operating room systems.

As an example, users of the different digital operating room systems generate their personal layouts of the ROI video streams for particular medical procedures and their workflow steps which are then used as training data for the local AI model in each digital operating room system. An overall AI model is synthesized from the parameters of multiple local AI models.

For example, the invention does not involve or in particular comprise or encompass an invasive step which would represent a substantial physical interference with the body requiring professional medical expertise to be carried out and entailing a substantial health risk even when carried out with the required professional care and expertise. The invention merely relates to video processing.

### Definitions

In this section, definitions for specific terminology used in this disclosure are offered which also form part of the present disclosure.

### Computer-Implemented Method

The method in accordance with the invention is for example a computer-implemented method. For example, all the steps or merely some of the steps (i.e. less than the total number of steps) of the method in accordance with the invention can be executed by a computer (for example, at least one computer). An embodiment of the computer implemented method is a use of the computer for performing a data processing method. An embodiment of the computer implemented method is a method concerning the operation of the computer such that the computer is operated to perform one, more or all steps of the method.

The computer for example comprises at least one processor and for example at least one memory in order to (technically) process the data, for example electronically and/or optically. The processor being for example made of a substance or composition which is a semiconductor, for example at least partly n- and/or p-doped semiconductor, for example at least one of II-, III-, IV-, V-, VI-semiconductor material, for example (doped) silicon and/or gallium arsenide. The calculating or determining steps described are for example performed by a computer. Determining steps or calculating steps are for example steps of determining data within the framework of the technical method, for example within the framework of a program. A computer is for example any kind of data processing device, for example electronic data processing device. A computer can be a device which is generally thought of as such, for example desktop PCs, notebooks, netbooks, etc., but can also be any programmable apparatus, such as for example a mobile phone or an embedded processor. A computer can for example comprise a system (network) of “sub-computers”, wherein each sub-computer represents a computer in its own right. The term “computer” includes a cloud computer, for example a cloud server. The term computer includes a server resource. The term “cloud computer” includes a cloud computer system which for example comprises a system of at least one cloud computer and for example a plurality of operatively interconnected cloud computers such as a server farm. Such a cloud computer is preferably connected to a wide area network such as the world wide web (WWW) and located in a so-called cloud of computers which are all connected to the world wide web. Such an infrastructure is used for “cloud computing”, which describes computation, software, data access and storage services which do not require the end user to know the physical location and/or configuration of the computer delivering a specific service. For example, the term “cloud” is used in this respect as a metaphor for the Internet (world wide web). For example, the cloud provides computing infrastructure as a service (IaaS). The cloud computer can function as a virtual host for an operating system and/or data processing application which is used to execute the method of the invention. The cloud computer is for example an elastic compute cloud (EC2) as provided by Amazon Web Services™. A computer for example comprises interfaces in order to receive or output data and/or perform an analogue-to-digital conversion. The data are for example data which represent physical properties and/or which are generated from technical signals. The technical signals are for example generated by means of (technical) detection devices (such as for example devices for detecting marker devices) and/or (technical) analytical devices (such as for example devices for performing (medical) imaging methods), wherein the technical signals are for example electrical or optical signals. The technical signals for example represent the data received or outputted by the computer. The computer is preferably operatively coupled to a display device which allows information outputted by the computer to be displayed, for example to a user. One example of a display device is a virtual reality device or an augmented reality device (also referred to as virtual reality glasses or augmented reality glasses) which can be used as “goggles” for navigating. A specific example of such augmented reality glasses is Google Glass (a trademark of Google, Inc.). An augmented reality device or a virtual reality device can be used both to input information into the computer by user interaction and to display information outputted by the computer. Another example of a display device would be a standard computer monitor comprising for example a liquid crystal display operatively coupled to the computer for receiving display control data from the computer for generating signals used to display image information content on the display device. A specific embodiment of such a computer monitor is a digital lightbox. An example of such a digital lightbox is Buzz®, a product of Brainlab AG. The monitor may also be the monitor of a portable, for example handheld, device such as a smart phone or personal digital assistant or digital media player.

The invention also relates to a computer program comprising instructions which, when on the program is executed by a computer, cause the computer to carry out the method or methods, for example, the steps of the method or methods, described herein and/or to a computer-readable storage medium (for example, a non-transitory computer-readable storage medium) on which the program is stored and/or to a computer comprising said program storage medium and/or to a (physical, for example electrical, for example technically generated) signal wave, for example a digital signal wave, such as an electromagnetic carrier wave carrying information which represents the program, for example the aforementioned program, which for example comprises code means which are adapted to perform any or all of the method steps described herein. The signal wave is in one example a data carrier signal carrying the aforementioned computer program. The invention also relates to a computer comprising at least one processor and/or the aforementioned computer-readable storage medium and for example a memory, wherein the program is executed by the processor.

Within the framework of the invention, computer program elements can be embodied by hardware and/or software (this includes firmware, resident software, micro-code, etc.). Within the framework of the invention, computer program elements can take the form of a computer program product which can be embodied by a computer-usable, for example computer-readable data storage medium comprising computer-usable, for example computer-readable program instructions, “code” or a “computer program” embodied in said data storage medium for use on or in connection with the instruction-executing system. Such a system can be a computer; a computer can be a data processing device comprising means for executing the computer program elements and/or the program in accordance with the invention, for example a data processing device comprising a digital processor (central processing unit or CPU) which executes the computer program elements, and optionally a volatile memory (for example a random access memory or RAM) for storing data used for and/or produced by executing the computer program elements. Within the framework of the present invention, a computer-usable, for example computer-readable data storage medium can be any data storage medium which can include, store, communicate, propagate or transport the program for use on or in connection with the instruction-executing system, apparatus or device. The computer-usable, for example computer-readable data storage medium can for example be, but is not limited to, an electronic, magnetic, optical, electromagnetic, infrared or semiconductor system, apparatus or device or a medium of propagation such as for example the Internet. The computer-usable or computer-readable data storage medium could even for example be paper or another suitable medium onto which the program is printed, since the program could be electronically captured, for example by optically scanning the paper or other suitable medium, and then compiled, interpreted or otherwise processed in a suitable manner. The data storage medium is preferably a non-volatile data storage medium. The computer program product and any software and/or hardware described here form the various means for performing the functions of the invention in the example embodiments. The computer and/or data processing device can for example include a guidance information device which includes means for outputting guidance information. The guidance information can be outputted, for example to a user, visually by a visual indicating means (for example, a monitor and/or a lamp) and/or acoustically by an acoustic indicating means (for example, a loudspeaker and/or a digital speech output device) and/or tactilely by a tactile indicating means (for example, a vibrating element or a vibration element incorporated into an instrument). For the purpose of this document, a computer is a technical computer which for example comprises technical, for example tangible components, for example mechanical and/or electronic components. Any device mentioned as such in this document is a technical and for example tangible device.

### Acquiring Data

The expression “acquiring data” for example encompasses (within the framework of a computer implemented method) the scenario in which the data are determined by the computer implemented method or program. Determining data for example encompasses measuring physical quantities and transforming the measured values into data, for example digital data, and/or computing (and e.g. outputting) the data by means of a computer and for example within the framework of the method in accordance with the invention. A step of “determining” as described herein for example comprises or consists of issuing a command to perform the determination described herein. For example, the step comprises or consists of issuing a command to cause a computer, for example a remote computer, for example a remote server, for example in the cloud, to perform the determination. Alternatively or additionally, a step of “determination” as described herein for example comprises or consists of receiving the data resulting from the determination described herein, for example receiving the resulting data from the remote computer, for example from that remote computer which has been caused to perform the determination. The meaning of “acquiring data” also for example encompasses the scenario in which the data are received or retrieved by (e.g. input to) the computer implemented method or program, for example from another program, a previous method step or a data storage medium, for example for further processing by the computer implemented method or program. Generation of the data to be acquired may but need not be part of the method in accordance with the invention. The expression “acquiring data” can therefore also for example mean waiting to receive data and/or receiving the data. The received data can for example be inputted via an interface. The expression “acquiring data” can also mean that the computer implemented method or program performs steps in order to (actively) receive or retrieve the data from a data source, for instance a data storage medium (such as for example a ROM, RAM, database, hard drive, etc.), or via the interface (for instance, from another computer or a network). The data acquired by the disclosed method or device, respectively, may be acquired from a database located in a data storage device which is operably to a computer for data transfer between the database and the computer, for example from the database to the computer. The computer acquires the data for use as an input for steps of determining data. The determined data can be output again to the same or another database to be stored for later use. The database or database used for implementing the disclosed method can be located on network data storage device or a network server (for example, a cloud data storage device or a cloud server) or a local data storage device (such as a mass storage device operably connected to at least one computer executing the disclosed method). The data can be made “ready for use” by performing an additional step before the acquiring step. In accordance with this additional step, the data are generated in order to be acquired. The data are for example detected or captured (for example by an analytical device). Alternatively or additionally, the data are inputted in accordance with the additional step, for instance via interfaces. The data generated can for example be inputted (for instance into the computer). In accordance with the additional step (which precedes the acquiring step), the data can also be provided by performing the additional step of storing the data in a data storage medium (such as for example a ROM, RAM, CD and/or hard drive), such that they are ready for use within the framework of the method or program in accordance with the invention. The step of “acquiring data” can therefore also involve commanding a device to obtain and/or provide the data to be acquired. In particular, the acquiring step does not involve an invasive step which would represent a substantial physical interference with the body, requiring professional medical expertise to be carried out and entailing a substantial health risk even when carried out with the required professional care and expertise. In particular, the step of acquiring data, for example determining data, does not involve a surgical step and in particular does not involve a step of treating a human or animal body using surgery or therapy. In order to distinguish the different data used by the present method, the data are denoted (i.e. referred to) as “XY data” and the like and are defined in terms of the information which they describe, which is then preferably referred to as “XY information” and the like.

### Medical Workflow

A medical procedure follows a medical workflow. A medical workflow comprises a plurality of workflow steps performed during a medical treatment and/or a medical diagnosis. The workflow steps are typically, but not necessarily performed in a predetermined order. Each workflow step for example means a particular task, which might be a single action or a set of actions. Examples of workflow steps are capturing a medical image, positioning a patient, attaching a marker, performing a resection, moving a joint, placing an implant and the like.

### BRIEF DESCRIPTION OF THE DRAWINGS

In the following, the invention is described with reference to the appended figures which give background explanations and represent specific embodiments of the invention. The scope of the invention is however not limited to the specific features disclosed in the context of the figures, wherein

FIG. 1 illustrates a digital operating room system according to the invention;

FIG. 2 shows an image of an input video stream;

FIG. 3 shows images of ROI video streams extracted from the input video stream;

FIG. 4 shows different layouts of an output video stream; and

FIG. 5 shows a flow diagram.

### DESCRIPTION OF EMBODIMENTS

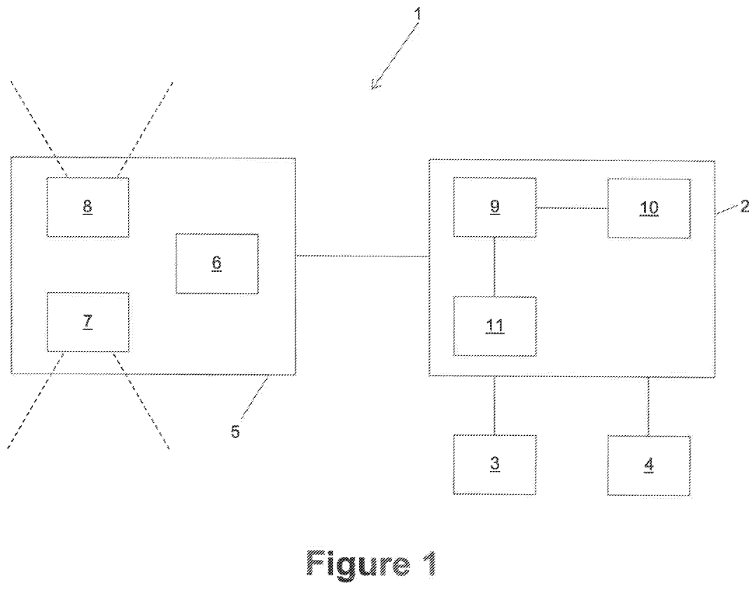

FIG. 1 is a schematic illustration of a digital operating room system 1 according to the fifth aspect. The system 1 comprises a computer 2, input means 3, output means 4 and a camera 5. The input means 3 can for example be a keyboard, a touch sensitive surface, a mouse or a combination thereof. The output means 5 can be a monitor or any other display. The camera 5 comprises a central processing unit 6 and two camera modules 7 and 8. The fields of view of the camera modules 7 and 8 are indicated by dashed lines.

Each camera module 7, 8 has an optical system and means for generating an electric output signal representing an image. The central processing unit 6 combines the outputs of the camera modules 7 and 8 into an input video stream, which is a sequence of images. The images of the input video stream are images stitched from the output of the camera modules 7 and 8 and show a horizontal 360 degrees view around the camera 5.

The computer 2 comprises a central processing unit 9, a memory 10 and an interface 11. The interface 11 connects the computer 2 to the camera 5, the input means 3 and the output means 4. The memory 10 stores data, like one or more images of the input video stream acquired from the camera 5, of one or more images of the ROI video streams generated by the central processing unit 9 and optionally of an output video stream generated by the central processing unit 9. The memory 10 further stores instructions to be performed by the central processing unit 9 in order to implement the present invention.

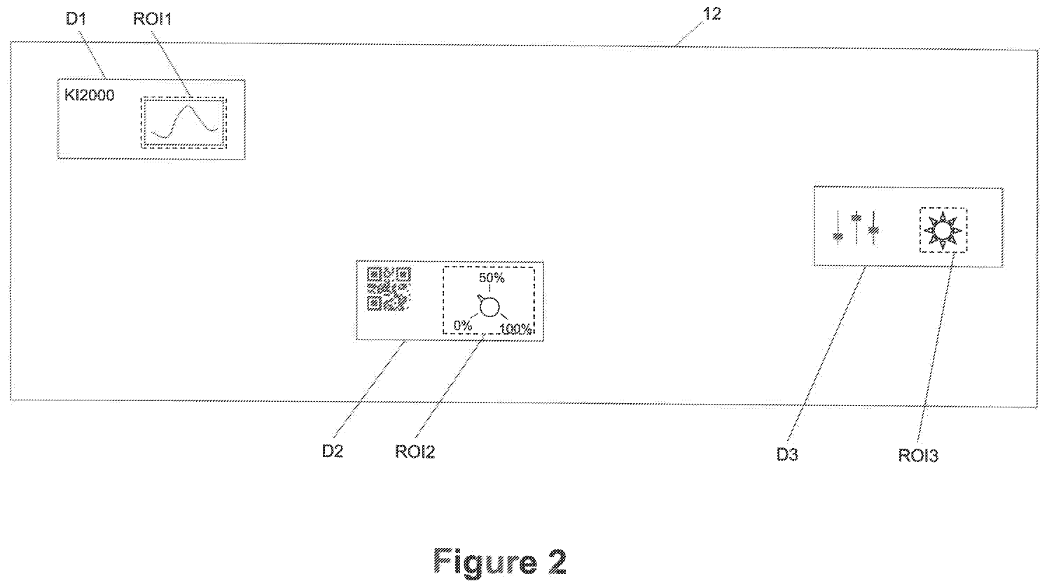

FIG. 2 shows an example of an image out of an input video stream 12 generated by the camera 5 and acquired by the central processing unit 9. The image shows three devices D1, D2 and D3. The device D1 has a region of interest ROI1 comprising a two-dimensional graphical display, the device D2 has a region of interest ROI2 comprising a rotary knob as an example of a control element and the device D3 has a region of interest ROI3 comprising a lamp as an example of a status indicator. All other content of the image is omitted.

The central processing unit analyzes the image of the input video stream 12 and identifies the three devices therein. The type of the device D1 is identified from the device name “KI2000” written thereon. A device database stored in the memory 10 holds a template of the identified type of device which defines a region of interest relative to the name written on the device D1 or the boundary of the device D1. Based on this information, the central processing unit identifies an area in the image of the input video stream 12 which shows the region of interest ROI1 of the device D1.

The device D2 is identified from the QR code written thereon. The device database stored in the memory 10 holds information which defines a region of interest relative to the QR code written on the device D2 or the boundary of the device D2. Based on this information, the central processing unit identifies an area in the image of the input video stream 12 which shows the region of interest ROI2 of the device D2.

The type of the device D3 is identified by matching sample images of devices comprised in the device database stored in the memory 10 with the input video stream 12. The device database stores information about a region of interest within the sample image. When matching the sample image to the input video stream 12, the region of interest in the sample image is also adapted and then defines an area in the image of the input video stream 12 which shows the region of interest ROI3 of the device D3.

The central processing unit 9 extracts the three areas showing the regions of interest ROI1, ROI2 and ROI3, respectively, and transforms them into ROI video streams 13, 14 and 15, respectively. This transformation involves image processing as necessary, like geometric distortion correction, rotation, contrast processing or color correction.

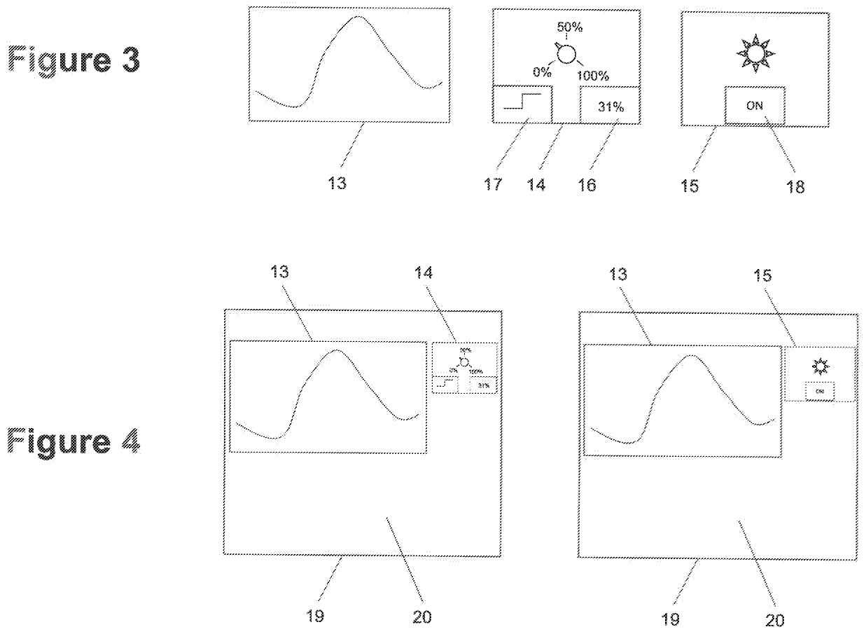

FIG. 3 shows images of each of the ROI video streams 13, 14 and 15. Each ROI video stream actually comprises a sequence of images. The ROI video stream 13 shows the display of the device D1.

The ROI video stream 14 shows the rotary knob of the device D2, but is further enhanced. In the lower right of the ROI video stream 14, a graphical representation 16 indicating the value set by the rotary knob 14 is overlaid. Said value is determined by the central processing unit 9 by analysis of the image of the input video stream 12 or of the ROI video stream 14. The device database stored in the memory 10 for example comprises a physical range in which the rotary knob can be adjusted and a corresponding range of values which can be set. The central processing unit 9 identifies the rotational position of the rotary knob relative to the device D2 and determines a corresponding value.

In the lower left, the ROI video stream 14 comprises a graphical representation 17 which is a graph showing the history of the values set using the rotary knob for a predetermined time. The central processing unit 9 saves set values identified from previous images of the input video stream 12 or of the ROI video stream 14 and generates the graphical representation 17.

The ROI video stream 15 shows the lamp of the device 3. The central processing unit 9 further analyzes the area of the input video stream 12 showing the region of interest ROI3 or the ROI video stream 15 to determine whether the lamp is on or off. The result of this analysis is transformed into a graphical representation 18 showing the word “on” or “off” depending on the identified status of the lamp. The graphical representation 18 is added to the ROI video stream 15.

FIG. 4 shows an output video stream 19 at two points in time. In general, the output video stream comprises a basic video stream 20 enhanced by one or more ROI video streams. The basic video stream can be blank, like a continuous image of any color, or any other video stream, such as a video stream generated by a camera and showing, for example, a patient. The operating room system 1 may further comprise an additional camera providing the basic video stream. The additional camera is for example directed to an operating room table.

At the first point in time shown in the left of FIG. 4, the ROI video stream 13 fills most of the output video stream 19 and the ROI video stream 14 is arranged much smaller and to the right of the ROI video stream 13. At the first point in time, a first workflow step of a medical workflow may be performed, wherein the device D2 is used in the first workflow step.

At the second point in time shown in the right of FIG. 4, the ROI video stream 13 again fills most of the output video stream 19 and the ROI video stream 15 is arranged much smaller and to the right of the ROI video stream 13. At the second point in time, a second workflow step of a medical workflow may be performed, wherein the device D3 is used in the second workflow step.

The memory 10 stores the layout of the output video stream 19, in particular defining the basic video stream to be used, which ROI video stream(s) to be used and the positions of the ROI video stream(s) in the output video stream 19. A layout is optionally associated with a workflow, or a workflow step, via a database of medical procedures stored in the memory 10.

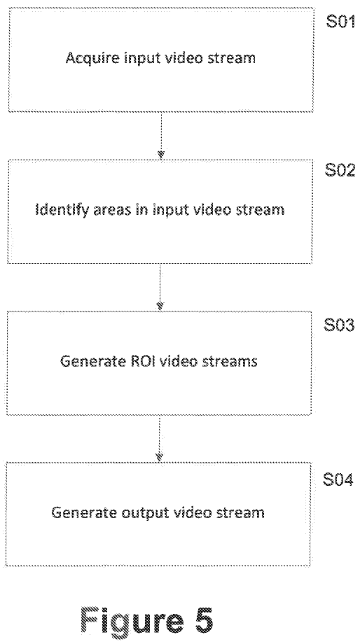

FIG. 5 shows a flow diagram of a general method according to the present invention.

The method starts with step S01 of acquiring the input video stream 12, for example from the camera 5. Step S02 involves identifying areas of the input video stream 12 which show regions of interest, like the regions of interest ROI1, ROI2 and ROI3. Step S03 involves generating ROI video streams 13, 14 and 15 from the identified areas. Step S04 involves generating an output video stream 19 from at least one of the ROI video streams 13, 14 and 15.

It shall be noted that any processing is typically based on a single image. So identifying an area in the input video stream 12, for example, means identifying an area in an image of the input video stream 12. So the term “video stream” can be read as “image of a video stream” where appropriate. The ROI video streams are typically generated image by image from subsequent images of the input video stream.

However, knowledge obtained from previous images might be used when processing an image. For example, a region of interest is not expected to move far between two subsequent images, such that the position of an identified area in the directly preceding image can be used as a starting point for identifying an area in the current image or for verifying an area identified in the current image.

However, knowledge gained from multiple images of an input video stream can be used, for example for generating a graphical representation added to an ROI video stream, like the graphical representation 17.

Instead of generating the output video stream 20, the computer 2 might output the ROI video streams 13, 14 and 15, for example via the interface 11 or any other suitable interface. For each ROI video stream 13, 14, 15, the computer can act as a virtual camera source or virtual video source. However, the central processing unit 9 form virtual cameras or virtual video sources providing the ROI video streams 13, 14, 15 within the computer 2, for example to video mixing software operating on the computer 2.

1. A data processing method of providing information about a device used in a medical environment, the method comprising:
acquiring an input video stream captured using a camera, the input video stream comprising a sequence of images showing one or more regions of interest (ROI), wherein each region of interest comprises a representation of a part of the device;
identifying one or more areas in the sequence of images of the input video stream that show the one or more regions of interest; and
generating an ROI video stream from the input video stream for each of the identified one or more areas.

2. The method of claim 1, wherein a region of interest comprises one or more of a display, a control element and/or a status indicator.

3. The method of claim 1, further comprising removing distortion from an ROI video stream, to provide a planar view onto the corresponding region of interest.

4. The method of claim 1, further comprising providing an ROI video stream as a virtual video source.

5. The method of claim 1, wherein the sequence of images in the input video stream are 360° images.

6. The method of claim 1, wherein the identifying the one or more areas comprises identifying the device in the input video stream, obtaining information that defines the corresponding region of interest from a database, and identifying the area based on the obtained information.

7. The method of claim 6, wherein identifying the device comprises identifying an identification tag of the device in the input video stream.

8. The method of claim 1, wherein the identifying the one or more areas comprises identifying the one or more areas using the position of the corresponding device relative to the camera.

9. The method of claim 1, further comprising acquiring user input data indicating a spatial position in the input video stream, wherein an identified area in the images of the input video stream is an area including the position indicated by the user input data.

10. The method of claim 1, further comprising acquiring user input data indicating a type of the device, wherein an area in the images of the input video stream is identified based on the indicated type of the device.

11. The method of claim 1, wherein the identifying the one or more areas in the sequence of images of the input video stream comprises identifying at least one of the one or more areas using artificial intelligence.

12. The method of claim 1, wherein the identifying the one or more areas in the sequence of images of the input video stream comprises identifying at least one of the one or more areas based on an aspect of a medical procedure that is currently being performed.

13. The method of claim 12, wherein the identifying the at least one of the one or more areas in the sequence of images of the input video stream comprises identifying at least one of the one or more areas based on a workflow step of the medical procedure that is currently being performed.

14. The method of claim 1, further comprising tracking a region of interest in the input video stream over time.

15. The method of claim 1, wherein a region of interest comprises a control element and wherein the method further comprises transforming a status of the control element into a graphical representation and embedding the graphical representation in the corresponding ROI video stream.

16. The method of claim 1, wherein a region of interest comprises a status indicator and wherein the method further comprises transforming the status indicated by the status indicator into a graphical representation and embedding the graphical representation in the corresponding ROI video stream.

17. The method of claim 1, wherein the generating the ROI video stream comprises generating the ROI video stream from at least one of two or more raw video streams obtained from two or more camera modules comprising the camera, wherein the acquired input video stream is a synthetization of the two or more raw video streams.

18. The method of claim 1, further comprising adding a graphical representation of device information to the ROI video stream.

19. The method of claim 1, further comprising generating an output video stream from at least one ROI video stream.

20. The method of claim 19, further comprising arranging the at least one ROI video stream in the output video stream based on user preferences.

21. The method of claim 19, further comprising arranging the at least one ROI video stream in the output video stream based on a medical procedure that is currently performed.

22. The method of claim 21, further comprising arranging the at least one ROI video stream in the output video stream based on a workflow step of the medical procedure that is currently performed.

23. The method of claim 19, further comprising using artificial intelligence to arrange the at least one ROI video stream in the output video stream.

24. (canceled)

25. A computer comprising:
a processor;
a non-transient memory device; and
logic stored in the non-transient memory device, the logic being executable by the processor to perform a method of providing information about a device used in a medical environment by:
acquiring an input video stream captured using a camera, the input video stream comprising a sequence of images showing one or more regions of interest, wherein a region of interest comprises a representation of a part of the device;
identifying one or more areas in the images of the input video stream that show the one or more regions of interest; and
generating an ROI video stream for each of the one or more areas.

26. (canceled)

27. (canceled)

28. The method according to claim 1, further comprising:
extracting the one or more areas of the input video stream that show the one or more regions of interest from the input video stream; and
providing the extracted one or more areas of the input video stream as the ROI video stream for each of the one or more areas.
